(19) United States
(12) Patent Application Publication
(10) Pub. No.: US 2020/0166859 A1
(43) Pub. Date: May 28, 2020

(54) TONER FOR DEVELOPING ELECTROSTATIC IMAGES

(71) Applicant: ZEON CORPORATION, Tokyo (JP)

(72) Inventor: Takeshi Hirata, Tokyo (JP)

(73) Assignee: ZEON CORPORATION, Tokyo (JP)

(21) Appl. No.: 16/632,638

(22) PCT Filed: Jul. 25, 2018
(86) PCT No.: PCT/JP2018/027970

§ 371 Date: Jan. 21, 2020

(30) Foreign Application Priority Data
Jul. 31, 2017 (JP) 2017-147786

(51) Int. Cl. G03G 9/087; G03G 9/08; G03G 9/097

(52) U.S. Cl. CPC G03G 9/08711; G03G 9/09741; G03G 9/0806

(57) ABSTRACT

The toner for developing electrostatic images comprises colored resin particles comprising a binder resin, a colorant, a charge control resin and a softening agent, and an external additive, wherein the charge control resin is a copolymer having a composition in which a content ratio of a methyl methacrylate monomer unit is from 85.0 to 99.7% by mass; a content ratio of a quaternary ammonium salt group-containing (meth)acrylate monomer unit is from 0.3 to 15.0% by mass; and a content ratio of a vinyl-based monomer unit other than the methyl methacrylate monomer unit and the quaternary ammonium salt group-containing (meth)acrylate monomer unit, is from 0 to 14.7% by mass, and wherein a content ratio of the charge control resin is from 0.2 to 4.0 parts by mass, with respect to 100 parts by mass of the binder resin.

### TECHNICAL FIELD

The present invention relates to a toner for developing electrostatic images which is applicable to development in electrophotographic image forming devices such as copying machines, facsimiles and printers, and a method for producing the same.

### BACKGROUND ART

In recent years, laser printers and copying machines using an electrophotographic system have been required to have a high speed and a long life, and a toner having high charge stability and durability has been demanded.

In an image forming method using electrophotography or electrostatic printing, charged toner particles are configured to develop an electrostatic latent image on a drum by an electrostatic force corresponding to a potential difference on the photoconductor drum. At this time, charging of the toner is specifically generated by friction between the toner and the toner, or between the toner and a carrier, and further between the toner and a regulating blade.

In general, when the toner particles are subjected to mechanical and thermal stress due to friction, an external additive is buried or released, the initial charge amount cannot be maintained, and fog is likely to occur. In particular, when used in a non-magnetic one-component developing device that charges a toner by friction with a regulating blade, these problems are serious problems.

In view of the above background, a toner having excellent charge stability and durability has been demanded, and improvements have been made to, for example, resin components, charge control agents and external additives used in the toner.

For example, Patent Literature 1 discloses a toner having colored resin particles containing a copolymer of at least one of acrylic acid ester and methacrylic acid ester and at least one of acrylic acid and methacrylic acid as a fixing aid. It is described that the toner is excellent in printing durability even under a wide range of temperature and humidity environments.

Patent Literature 2 discloses a toner containing a charge control resin having a structure in which an aromatic ring and a salicylic acid structure are bonded via an alkyl ether. It is described that the toner is excellent in durability by suppressing an increase in cohesiveness when making a large number of printouts.

### CITATION LIST

### Patent Literature

[Patent Literature 1] JP 5598640 B2

[Patent Literature 2] Japanese Patent Application Laid-Open (JP-A) No. 2017-032682

### SUMMARY OF INVENTION

### Technical Problem

However, since the toners described in Patent Literature 1 and Patent Literature 2 contain a resin having a highly polar functional group as a fixing aid or a charge control resin, the toners have problems that durability tends to decrease in a high humidity environment, and a conveyance amount on a developing roller increases.

The present invention has been accomplished in view of the above circumstances, and an object of the present invention is to provide a toner for developing electrostatic images that is excellent in printing durability in a high temperature and high humidity environment and also excellent in conveyance amount stability on the developing roller.

### Solution to Problem

As a result of an extensive study to achieve the object, the present inventors have found that the object can be achieved by incorporating a specific amount of a charge control agent having a specific composition into the colored resin particles constituting the toner for developing electrostatic images.

According to the present invention, a toner for developing electrostatic images is provided, the toner comprising: colored resin particles comprising a binder resin, a colorant, a charge control resin and a softening agent, and an external additive, wherein the charge control resin is a copolymer having a composition in which a content ratio of a methyl methacrylate monomer unit is from 85.0% by mass to 99.7% by mass; a content ratio of a quaternary ammonium salt group-containing (meth)acrylate monomer unit is from 0.3% by mass to 15.0% by mass; and a content ratio of a vinyl-based monomer unit other than the methyl methacrylate monomer unit and the quaternary ammonium salt group-containing (meth)acrylate monomer unit, is from 0% by mass to 14.7% by mass, and wherein a content ratio of the charge control resin is from 0.2 parts by mass to 4.0 parts by mass, with respect to 100 parts by mass of the binder resin.

In the toner for developing electrostatic images according to the present invention, a glass transition temperature of the charge control resin is preferably from 50° C. to 85° C., and the binder resin is preferably a copolymer having a composition in which a content ratio of a styrene monomer unit is from 55% by mass to 75% by mass, and a content ratio of an alkyl (meth)acrylate monomer unit is from 25% by mass to 45% by mass and having a glass transition temperature of from 30° C. to 55° C.

In the toner for developing electrostatic images according to the present invention, a content ratio of the quaternary ammonium salt group-containing (meth)acrylate monomer unit in the toner for developing electrostatic images, is preferably from 40 ppm to 250 ppm.

According to the present invention, a method for producing a toner for developing electrostatic images is provided, the method comprising: a suspension step of obtaining a suspension in which droplets of a polymerizable monomer composition comprising at least a polymerizable monomer, a colorant, a charge control resin and a softening agent are dispersed, by suspending the polymerizable monomer composition in an aqueous dispersion medium comprising a dispersion stabilizer, and a step of obtaining colored resin particles by suspension polymerization of the suspension in the presence of a polymerization initiator, wherein the charge control resin is a copolymer having a composition in which a content ratio of a methyl methacrylate monomer unit is from 85.0% by mass to 99.7% by mass; a content ratio of a quaternary ammonium salt group-containing (meth)acrylate monomer unit is from 0.3% by mass to 15.0% by mass; and a content ratio of a vinyl-based monomer unit other than the methyl methacrylate monomer unit and the quaternary ammonium salt group-containing (meth)acrylate monomer unit, is from 0% by mass to 14.7% by mass, and wherein an added amount of the charge control resin in the suspension step, is from 0.2 parts by mass to 4 parts by mass, with respect to 100 parts by mass of the polymerizable monomer.

### Advantageous Effects of Invention

According to the present invention, a toner that is excellent in the printing durability in a high temperature and high humidity environment and also excellent in the conveyance amount stability on the developing roller, by containing, with respect to 100 parts by mass of the binder resin, 0.2 parts by mass to 4.0 parts by mass of a charge control resin that is a copolymer having a composition in which a content ratio of a methyl methacrylate monomer unit is from 85.0% by mass to 99.7% by mass; a content ratio of a quaternary ammonium salt group-containing (meth)acrylate monomer unit is from 0.3% by mass to 15.0% by mass; and a content ratio of a vinyl-based monomer unit other than the methyl methacrylate monomer unit and the quaternary ammonium salt group-containing (meth)acrylate monomer unit is in a range of from 0% by mass to 14.7% by mass.

### DESCRIPTION OF EMBODIMENTS

A toner for developing electrostatic images of the present invention comprises colored resin particles comprising a binder resin, a colorant, a charge control resin and a softening agent, and an external additive, wherein the charge control resin is a copolymer having a composition in which a content ratio of a methyl methacrylate monomer unit is from 85.0% by mass to 99.7% by mass; a content ratio of a quaternary ammonium salt group-containing (meth)acrylate monomer unit is from 0.3% by mass to 15.0% by mass; and a content ratio of a vinyl-based monomer unit other than the methyl methacrylate monomer unit and the quaternary ammonium salt group-containing (meth)acrylate monomer unit, is from 0% by mass to 14.7% by mass, and wherein a content ratio of the charge control resin is from 0.2 parts by mass to 4.0 parts by mass, with respect to 100 parts by mass of the binder resin.

Hereinafter, the toner for developing electrostatic images of the present invention (hereinafter sometimes simply referred to as “toner”) will be described. In the present invention, “(meth)acrylic acid” is a term indicating acrylic acid and methacrylic acid, and “(meth)acrylate” is a term indicating acrylate and methacrylate.

The toner of the present invention has colored resin particles containing a binder resin, a colorant, a specific charge control resin and a softening agent, and an external additive.

As described above, in recent laser printers and copying machines using a high-performance electrophotographic system, a toner having both toner conveyance amount stability on the developing roller and printing durability at high levels has been demanded.

Since a large charge amount can be imparted to the toner in a small amount, a charge control resin having a highly polar functional group as described in Patent Literature 2 has been used as a means for stabilizing the conveyance amount.

In general, a means for increasing the charge control resin in the colored resin particles has been used as a means for improving printing durability of the toner. Increasing the charge control resin in the colored resin particles increases a thickness of the charge control resin layer that is unevenly distributed on the surface of the colored resin particles, so that changes in the surface state due to mechanical stress applied during printing are suppressed and a change in charge amount hardly occurs, and as a result, it is estimated that the printing durability of the toner is improved.

However, when a charge control resin having a highly polar functional group that has been used conventionally is used, increasing the amount of the charge control resin in the colored resin particles for the purpose of improving the printing durability makes the polarity of the toner too high. Therefore, a problem that the printing durability in a high temperature and high humidity environment is deteriorated is generated. In addition, since the charge amount of the toner becomes too large, the amount of toner conveyed onto the developing roller also becomes unstable, so that there was a limit in increasing the charge control resin in the colored resin particles for the purpose of improving printing durability.

In the present invention, the composition of the constituent monomer unit of the charge control resin having a highly polar functional group was studied, and a polarity of the charge control resin and a charge amount imparted to the colored resin particles are optimized by having a composition in which a content ratio of a methyl methacrylate monomer unit was from 85.0% by mass to 99.7% by mass; a content ratio of a quaternary ammonium salt group-containing (meth)acrylate monomer unit was from 0.3% by mass to 15.0% by mass; and a content ratio of a vinyl-based monomer unit other than the methyl methacrylate monomer unit and the quaternary ammonium salt group-containing (meth)acrylate monomer unit was in a range of from 0% by mass to 14.7% by mass, thereby enabling to provide a toner that has both required levels of the printing durability in a high temperature and high humidity environment and the stability of the amount of toner conveyed onto the developing roller required for recent toners.

Hereinafter, a production method of a colored resin particles used in the toner of the present invention, the colored resin particles obtained by the production method, a production method of the toner of the present invention using the colored resin particles, and the toner of the present invention will be described in sequence.

### 1. Method for Producing Colored Resin Particles

Generally, methods for producing the colored resin particles are broadly classified into dry methods such as a pulverization method and wet methods such as an emulsion polymerization agglomeration method, a suspension polymerization method and a solution suspension method. The wet methods are preferable since toners having excellent printing characteristics such as image reproducibility can be easily obtained. Among the wet methods, polymerization methods such as the emulsion polymerization agglomeration method and the suspension polymerization method are preferable since toners which have relatively small particle size distribution in micron order can be easily obtained. Among the polymerization methods, the suspension polymerization method is more preferable.

The emulsion polymerization agglomeration method is a method for producing colored resin particles by polymerizing emulsified polymerizable monomers to obtain a resin microparticle emulsion, and aggregating the resultant resin microparticles with a colorant dispersion, etc. The solution suspension method is a method for producing colored resin particles by forming droplets of a solution in an aqueous medium, the solution containing toner components such as a binder resin and a colorant dissolved or dispersed in an organic solvent, and removing the organic solvent. Both methods can be performed by known methods.

The colored resin particles used in the toner of the present invention can be produced by employing the wet methods or the dry methods. The suspension polymerization method is preferable among the wet methods. When the suspension polymerization method is employed, the colored resin particles may be produced by the following processes.

### (A) Suspension Polymerization Method

### (A-1) Preparation Step of Polymerizable Monomer Composition

First, a polymerizable monomer, a colorant, a charge control resin and a softening agent, and in addition, other additives such as a fixing aid as well, which are added if required, are mixed to prepare a polymerizable monomer composition. For example, a media type dispersing machine is used for the mixing in preparation of the polymerizable monomer composition.

In the present invention, the polymerizable monomer means a monomer having a polymerizable functional group, and a binder resin is made by polymerization of the polymerizable monomer. It is preferable to use a monovinyl monomer as a main component of the polymerizable monomer.

Examples of the monovinyl monomer include styrene; styrene derivatives such as vinyltoluene and α-methylstyrene; acrylic acid and methacrylic acid; acrylic acid esters (acrylates) such as methyl acrylate, ethyl acrylate, propyl acrylate, butyl acrylate, 2-ethylhexyl acrylate and dimethylaminoethyl acrylate; methacrylic acid esters (methacrylates) such as methyl methacrylate, ethyl methacrylate, propyl methacrylate, butyl methacrylate, 2-ethylhexyl methacrylate and dimethylaminoethyl methacrylate; nitrile compounds such as acrylonitrile and methacrylonitrile; amide compounds such as acrylamide and methacrylamide; and olefins such as ethylene, propylene and butylene. These monovinyl monomers may be used solely or in combination of two or more kinds. Among them, it is preferable to use styrene, styrene derivatives, acrylic acid esters or methacrylic acid esters as a monovinyl monomer.

From the viewpoint of improving low-temperature fixability, the polymerizable monomer preferably has a composition containing from 55% by mass to 75% by mass of styrene and from 25% by mass to 45% by mass of alkyl (meth)acrylate. This is because, by using the polymerizable monomer having such a composition, the glass transition temperature (hereinafter sometimes referred to as “Tg”) of a copolymer obtained by polymerization, that is, a binder resin, can be set in a range from 30° C. to 55° C.

In order to improve the hot offset and storage stability, it is preferable to use any crosslinkable polymerizable monomer together with the monovinyl monomer. The crosslinkable polymerizable monomer means a monomer having two or more polymerizable functional groups. Examples of the crosslinkable polymerizable monomer include: aromatic divinyl compounds such as divinyl benzene, divinyl naphthalene and derivatives thereof; ester compounds such as ethylene glycol dimethacrylate and diethylene glycol dimethacrylate, in which two or more carboxylic acids having a carbon-carbon double bond are esterified to alcohol having two or more hydroxyl groups; other divinyl compounds such as N,N-divinylaniline and divinyl ether; and compounds having three or more vinyl groups. These crosslinkable polymerizable monomers can be used solely or in combination of two or more kinds.

In the present invention, it is desirable that the amount of the crosslinkable polymerizable monomer to be used is generally from 0.1 parts by mass to 5 parts by mass, preferably from 0.3 parts by mass to 2 parts by mass, with respect to 100 parts by mass of the monovinyl monomer.

Further, a macromonomer can be used as a part of the polymerizable monomer. The use of the macromonomer gives rise to a good balance between the storage stability and low-temperature fixability of the toner, thus being preferable. The macromonomer has a polymerizable carbon-carbon unsaturated double bond at the end of the molecular chain and is a reactive oligomer or polymer which usually has a number average molecular weight of from 1,000 to 30,000. It is preferable that the macromonomer can form a polymer having a glass transition temperature higher than that of a polymer obtained by polymerizing a monovinyl monomer.

An used amount of the macromonomer is preferably from 0.03 parts by mass to 5 parts by mass, more preferably from 0.05 parts by mass to 1 parts by mass with respect to 100 parts by mass of the monovinyl monomer.

In the present invention, a colorant is used. To produce a color toner, a black colorant, a cyan colorant, a yellow colorant and a magenta colorant can be used.

Examples of the black colorant to be used include carbon black, titanium black and magnetic powder such as zinc-iron oxide and nickel-iron oxide.

Examples of the cyan colorant to be used include copper phthalocyanine compounds, derivatives thereof and anthraquinone compounds. The specific examples include C. I. Pigment Blue 2, 3, 6, 15, 15:1, 15:2, 15:3, 15:4, 16, 17:1 and 60.

Examples of the yellow colorant to be used include compounds including azo pigments such as monoazo pigments and disazo pigments, and condensed polycyclic pigments. The specific examples include C. I. Pigment Yellow 3, 12, 13, 14, 15, 17, 62, 65, 73, 74, 83, 93, 97, 120, 138, 155, 180, 181, 185, 186 and 213.

Examples of the magenta colorant to be used include compounds including azo pigments such as monoazo pigments and disazo pigments, and condensed polycyclic pigments. The specific examples include C. I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, 237, 238, 251, 254, 255 and 269, and C. I. Pigment Violet 19.

In the present invention, these colorants can be used alone or in combination of two or more kinds. The amount of the colorant is preferably in the range from 1 part by mass to 10 parts by mass, with respect to 100 parts by mass of the monovinyl monomer.

In the present invention, in order to obtain the above-described effects of the present invention, a charge control resin which is a copolymer having a composition in which a content ratio of a methyl methacrylate monomer unit is from 85.0% by mass to 99.7% by mass; a content ratio of a quaternary ammonium salt group-containing (meth)acrylate monomer unit is from 0.3% by mass to 15.0% by mass; and a content ratio of a vinyl-based monomer unit other than the methyl methacrylate monomer unit and the quaternary ammonium salt group-containing (meth)acrylate monomer unit is from 0% by mass to 14.7% by mass, is used.

The amount of the charge control resin to be used is from 0.2 parts by mass to 4.0 parts by mass, preferably from 0.5 parts by mass to 3.5 parts by mass, and further preferably from 1.0 parts by mass to 3.0 parts by mass, with respect to 100 parts by mass of the polymerizable monomer. When the amount of the charge control resin to be used is outside the above ranges, it is difficult to obtain the effects of the present invention.

The vinyl monomer unit constituting the charge control resin used in the present invention is a repeating unit obtained by a polymerization reaction of a vinyl-based monomer.

In the charge control resin used in the present invention, as the vinyl-based monomer unit, a methyl methacrylate monomer unit and a quaternary ammonium salt group-containing (meth)acrylate monomer unit are contained, and further, a vinyl-based monomer unit other than the methyl methacrylate monomer unit and the quaternary ammonium salt group-containing (meth)acrylate monomer unit may be contained.

The charge control resin used in the present invention has a composition in which the content ratio of the methyl methacrylate monomer unit is from 85.0% by mass to 99.7% by mass. In the present invention, by using a copolymer having a composition in which the content ratio of the methyl methacrylate monomer unit is from 85.0% by mass to 99.7% by mass in combination with the quaternary ammonium salt group-containing (meth)acrylate monomer unit as the charge control resin, it is possible to obtain a toner having excellent printing durability in a high temperature and high humidity environment and also excellent in the conveyance amount stability on the developing roller.

A reason why the effects of the present invention is obtained when the charge control resin used in the present invention contains the methyl methacrylate monomer unit at a specific ratio is not clear, but is estimated as follows.

Since the methyl methacrylate monomer is more polar than vinyl-based monomers such as styrene and n-butyl acrylate, the charge control resin containing the methyl methacrylate monomer in the above ratio is likely to be unevenly distributed on the surface of the colored resin particles. Also, the methyl methacrylate monomer has a lower affinity for water than the monomer having an acidic or basic functional group. Therefore, when a charge control resin containing the methyl methacrylate monomer in the above ratio is used, it is difficult for moisture to be adsorbed on the surface of the colored resin particles, and adhesion between the toners due to the liquid crosslinking force is unlikely to increase.

For these reasons, it is estimated that the printing durability of the toner, particularly the printing durability in a high temperature and high humidity environment, can be increased.

The content ratio of the methyl methacrylate monomer unit is preferably from 85.0% by mass to 99.7% by mass, and more preferably from 95.0% by mass to 99.6% by mass.

When the content ratio of the methyl methacrylate monomer unit exceeds the above ranges, a sufficient charge amount may not be obtained. When the methyl methacrylate monomer unit is less than the above ranges, the conveyance amount stability may be lowered.

The charge control resin used in the present invention has a composition in which the content ratio of the quaternary ammonium salt group-containing (meth)acrylate monomer unit is from 0.3% by mass to 15.0% by mass. The content ratio of the quaternary ammonium salt group-containing (meth)acrylate monomer unit is preferably from 0.3% by mass to 10.0% by mass, more preferably from 0.35% by mass to 8.0% by mass, and further preferably from 0.4% by mass to 5.0% by mass.

When the content ratio of the quaternary ammonium salt group-containing (meth)acrylate monomer unit is outside the above ranges, it becomes difficult to adjust the charge amount of the charge control resin to an appropriate range.

The quaternary ammonium salt group-containing (meth)acrylate monomer unit constituting the charge control resin used in the present invention is, for example, a repeating unit represented by a formula (A):

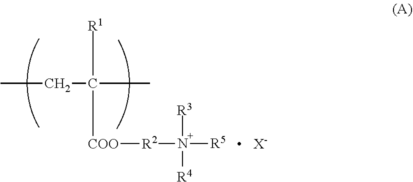

wherein R¹ is a hydrogen atom or a methyl group, R² is an alkylene group having 1 to 3 carbon atoms, and R³ to R⁵ are each independently an alkyl group having 1 to 6 carbon atoms, a phenyl group, or aralkyl having 1 to 12 carbon atoms, and X is a halogen group, an alkyl sulfonic acid group having 1 to 6 carbon atoms, a benzene sulfonic acid group, or a paratoluene sulfonic acid group.

The charge control resin used in the present invention has a composition in which the content ratio of the vinyl-based monomer unit other than the methyl methacrylate monomer unit and the quaternary ammonium salt group-containing (meth)acrylate monomer unit is in a range of from 0% by mass to 14.7% by mass.

When the charge control resin has the methyl methacrylate monomer unit and the quaternary ammonium salt group-containing (meth)acrylate monomer unit in the above-described content ratios, the effects of the present invention can be obtained when the content ratio of the vinyl-based monomer unit other than the methyl methacrylate monomer unit and the quaternary ammonium salt group-containing (meth)acrylate monomer unit is in a range of from 0% by mass to 14.7% by mass.

The content ratio of the vinyl-based monomer unit other than the methyl methacrylate monomer unit and the quaternary ammonium salt group-containing (meth)acrylate monomer unit is preferably from 0.1% by mass to 10.0% by mass, and more preferably from 0.5% by mass to 8.0% by mass.

When the content ratio of the vinyl-based monomer unit other than the methyl methacrylate monomer unit and the quaternary ammonium salt group-containing (meth)acrylate monomer unit exceeds the above ranges, printing durability decreases.

As vinyl-based monomer unit other than the methyl methacrylate monomer unit and the quaternary ammonium salt group-containing (meth)acrylate monomer unit, representative examples include a vinyl aromatic hydrocarbon monomer, and a (meth)acrylate monomer.

As the vinyl aromatic hydrocarbon monomer, specific examples include styrene; styrene derivatives such as vinyl toluene and α-methylstyrene; aromatic divinyl compounds such as divinyl benzene, divinyl naphthalene and derivatives thereof.

As the (meth)acrylate monomer, specific examples include acrylic acid esters (acrylates) such as methyl acrylate, ethyl acrylate, propyl acrylate, isopropyl acrylate, n-butyl acrylate, isobutyl acrylate, n-amyl acrylate, isoamyl acrylate, n-hexyl acrylate, and 2-ethylhexyl acrylate; and methacrylic acid esters (methacrylates) such as ethyl methacrylate, propyl methacrylate, isopropyl methacrylate, n-butyl methacrylate, isobutyl methacrylate, n-amyl methacrylate, isoamyl methacrylate, n-hexyl methacrylate, and 2-ethylhexyl methacrylate; ester compounds such as ethylene glycol dimethacrylate and diethylene glycol dimethacrylate, in which two or more carboxylic acids having a carbon-carbon double bond are esterified to alcohol having two or more hydroxyl groups.

In the present invention, content rates of the methyl methacrylate monomer unit, the quaternary ammonium salt group-containing (meth)acrylate monomer unit, and the vinyl-based monomer unit other than the methyl methacrylate monomer unit and the quaternary ammonium salt group-containing (meth)acrylate monomer unit in the charge control resin can be calculated on the basis of the charging ratio of each monomer in the polymerization reaction. In addition, when the polymerization conditions are unknown, it can be measured by instrumental analysis such as ¹H-NMR spectrum or IR spectrum.

The Tg of the charge control resin is preferably from 50° C. to 85° C., more preferably from 55° C. to 80° C., and more preferably from 60° C. to 75° C., from the viewpoint of low-temperature fixability.

Also, when the difference between the Tg of the binder resin component and the Tg of the charge control resin is from 0° C. to 55° C. and preferably from 0° C. to 15° C., it is preferable because the balance between low-temperature fixability, storage stability and fluidity is excellent and it provides stable print quality.

In the present invention, the Tg of the charge control resin can be a value measured by a differential thermometer (DSC). Moreover, the Tg of the charge control resin may also be a value obtained using additivity of the glass transition temperature of the polymer described later.

The lower limit of the monodisperse polystyrene equivalent weight average molecular weight (hereinafter sometimes referred to as Mw) of the charge control resin measured by gel permeation chromatography (GPC) using tetrahydrofuran is usually 2,000 or more, preferably 10,000 or more, further preferably 17,000 or more, and particularly preferably 20,000, and the upper limit is usually 40,000 or less, preferably 35,000 or less, further preferably 30,000 or less, and particularly preferably 28,000. When the weight average molecular weight is too large, handling during production of the toner particles is poor, and the size of droplets varies, so that uniform toner particles cannot be obtained. On the contrary, when the weight average molecular weight is too small, dispersibility of the pigment and chargeability are insufficient, and there is a problem of fogging of a printed sample.

The charge control resin used in the present invention can be produced by the following methods.

(1) A method to obtain the charge control resin by copolymerizing the methyl methacrylate monomer, the quaternary ammonium salt group-containing (meth)acrylate monomer, and the vinyl-based monomer other than the methyl methacrylate monomer and the quaternary ammonium salt group-containing (meth)acrylate monomer.

(2) A method to obtain the charge control resin by reacting the copolymer obtained by the method (1) with para-toluenesulfonic acid, methanesulfonic acid or the like.

(3) A method to obtain the charge control resin by copolymerizing the methyl methacrylate monomer, a dialkylaminoalkyl (meth)acrylate monomer, and the vinyl-based monomer other than the methyl methacrylate monomer and the quaternary ammonium salt group-containing (meth)acrylate monomer, and quaternizing nitrogen atoms of dialkylaminoalkyl groups in the thus-obtained copolymer with a quaternizing agent.

As the quaternary ammonium salt group-containing (meth)acrylate monomer used in the method (1) or (2), examples include N,N,N-trimethyl-N-(2-methacryloxyethyl)ammonium chloride (DMC or dimethylaminoethyl methacrylate methyl chloride) and N-benzyl-N,N-dimethyl-N-(2-methacryloxyethyl)ammonium chloride (DML or dimethylaminoethyl methacrylate benzyl chloride). The quaternary ammonium salt group-containing (meth)acrylate monomer can also be obtained by quaternizing an amino group-containing (meth)acrylate monomer with a quaternizing agent such as a halogenated organic compound or an acid esterifying agent.

As the dialkylaminoalkyl (meth)acrylate monomer used in the method (3), examples include dimethylaminoethyl (meth)acrylate, diethylaminoethyl (meth)acrylate, dipropylmethylaminoethyl (meth)acrylate, and dibutylaminoethyl (meth)acrylate.

As the quaternizing agent, examples include halogenated organic compounds such as methyl chloride, methyl bromide, ethyl chloride, ethyl bromide, benzyl chloride and benzyl bromide, and sulfonic acid alkyl esters such as methylsulfonic acid alkyl ester, ethylsulfonic acid alkyl ester, propylsulfonic acid alkyl ester, benzenesulfonic acid alkyl ester, and para-toluenesulfonic acid alkyl ester.

A polymerization method for obtaining the charge control resin used in the present invention may be any method such as emulsion polymerization, dispersion polymerization, suspension polymerization or solution polymerization, but solution polymerization is particularly preferable since the desired weight average molecular weight can be obtained.

When polymerizing by solution polymerization, an organic solvent is required. As the organic solvent, for example, general solvents such as hydrocarbon solvents, alcohol solvents, ketone solvents, ester solvents, amide solvents, ether solvents, and carbon chloride solvents can be used. These solvents can be used solely or in combination of two or more kinds.

The polymerization temperature and polymerization time can be arbitrarily selected depending on the polymerization method and the type of polymerization initiator used, but the polymerization temperature is usually about from 50° C. to 200° C., and the polymerization time is about from 0.5 to 20 hours. Furthermore, in polymerization, commonly known additives such as polymerization aids such as amines can also be used in combination. After solution polymerization, the polymerization solution may be used as it is to obtain toner particles, or a copolymer may be isolated by performing an operation such as adding the polymerization solution to a poor solvent, removing the solvent with steam or removing the solvent under reduced pressure, and then used.

In the production of the colored resin particles used in the present invention, a softening agent is added to the polymerizable monomer. The colored resin particles preferably contain, as the softening agent, a monoester compound which has a structure represented by the following formula (1) and a melting point of from 60° C. to 75° C.:

R¹—COO—R² Formula (1)

wherein R¹ is a straight-chain alkyl group having 15 to 21 carbon atoms, and R² is a straight-chain alkyl group having 16 to 22 carbon atoms. R¹ and R² can be groups which are the same as or different from each other. In the monoester compound represented by the formula (1), the difference between the carbon number of the raw material fatty acid (i.e., the carbon number obtained by adding 1 to the carbon number of R¹) and the carbon number of the raw material alcohol (i.e., the carbon number of R²) is preferably from 0 to 6, more preferably from 4 to 6.

When the melting point of the monoester compound is less than 60° C., the toner may be poor in heat-resistant storage stability. When the melting point of the monoester compound exceeds 75° C., low-temperature fixability may lower.

The melting point of the monoester compound is more preferably from 63° C. to 72° C., more preferably from 65° C. to 70° C.

Specific examples of the monoester compound represented by the formula (1) include behenyl palmitate (C₁₅H₃₁—COO—C₂₂H₄₅), behenyl stearate (C₁₇H₃₅—COO—C₂₂H₄₅), behenyl eicosanoate (C₁₉H₃₉—COO—C₂₂H₄₅), behenyl behenate (C₂₁H₄₃—COO—C₂₂H₄₅), eicosyl palmitate (C₁₅H₃₁—COO—C₂₀H₄₅), eicosyl stearate (C₁₇H₃₅—COO—C₂₀H₄₁), eicosyl eicosanoate (C₁₉H₃₉—COO—C₂₃H₄₁), eicosyl behenate (C₂₁H₄₃—COO—C₂₀H₄₁), stearyl stearate (C₁₇H₃₅—COO—C₁₈H₃₇), stearyl eicosanoate (C₁₉H₃₉—COO—C₁₈H₃₇), stearyl behenate (C₂₁H₄₃—COO—C₁₈H₃₇), hexadecyl eicosanoate (C₁₉H₃₉—COO—C₁₆H₃₃) and hexadecyl behenate (C₂₁H₄₃—COO—C₁₆H₃₃). Of these monoester compounds, behenyl stearate, behenyl palmitate and stearyl behenate are more preferred.

The content of the softening agent is preferably from 10 parts by mass to 25 parts by mass, with respect to 100 parts by mass of the colored resin particles. In the case of using two or more kinds of softening agents, the total content of all softening agents is preferably from 10 parts by mass to 25 parts by mass, with respect to 100 parts by mass of the colored resin particles. When the content of the softening agent is less than 10 parts by mass, the content is too small and may result in a deterioration in low-temperature fixability. When the content of the softening agent exceeds 25 parts by mass, the content is too large and may result in a deterioration in heat-resistant storage stability and durability.

The content of the softening agent is more preferably from 12 parts by mass to 22 parts by mass, even more preferably from 15 parts by mass to 20 parts by mass, with respect to 100 parts by mass of the colored resin particles.

As the softening agent, other ester compounds may be contained. Examples thereof include pentaerythritol ester compounds such as pentaerythritol tetrabehenate, pentaerythritol tetrapalminate and pentaerythtol tetrastearate, and glycerin ester compounds such as hexaglycerin octabehenate, pentaglycerin heptabehenate, tetraglycerin hexabehenate, triglycerin pentabehenate, diglycerin tetrabehenate and glycerin tribehenate.

The acid value of the monoester compound is preferably 1.0 mgKOH/g or less, more preferably 0.6 mgKOH/g or less, even more preferably 0.3 mgKOH/g or less. When the acid value is larger than 1.0 mgKOH/g, storage stability may deteriorate. The acid value of the monoester compound is a value measured in conformity to JIS K 0070, which is a standard method for the analysis of fats and oils established by Japanese Industrial Standards Committee (JICS).

The hydroxyl value of the monoester compound is preferably 10 mgKOH/g or less, more preferably 6 mgKOH/g or less, even more preferably 3 mgKOH/g or less. When the hydroxyl value is larger than 10 mgKOH/g, storage stability may deteriorate. The hydroxyl value of the monoester compound is a value measured in conformity to JIS K 0070, which is a standard method for the analysis of fats and oils established by Japanese Industrial Standards Committee (JICS).

It is preferable that the monoester compound satisfies both of the above-described acid value and hydroxyl value conditions.

As the method for producing the softening agent, there may be mentioned a method of synthesis by an oxidation reaction, synthesis from carboxylic acid and derivatives thereof, ester group introducing reactions as typified by the Michael addition reaction, a method using a dehydration-condensation reaction from a carboxylic acid compound and an alcohol compound, a reaction from an acid halide and an alcohol compound, and an ester-exchange reaction. In the production of the softening agent, a catalyst can be appropriately used. As the catalyst, a general acidic or alkaline catalyst used in the esterification reaction, such as zinc acetate or a titanium compound, are preferable. After the esterification reaction, the target product can be purified by recrystallization, distillation, etc.

In the present invention, it is preferable to use a molecular weight modifier as the other additives, when the polymerizable monomer which becomes a binder resin is polymerized.

The molecular weight modifier is not particularly limited as long as it is generally used as a molecular weight modifier for a toner. Examples of the molecular weight modifier include mercaptans such as t-dodecyl mercaptan, n-dodecyl mercaptan, n-octyl mercaptan and 2,2,4,6,6-pentamethylheptane-4-thiol; and thiuram disulfides such as tetramethyl thiuram disulfide, tetraethyl thiuram disulfide, tetrabutyl thiuram disulfide, N,N′-dimethyl-N,N′-diphenyl thiuram disulfide and N,N′-dioctadecyl-N,N′-diisopropyl thiuram disulfide. These molecular weight modifiers may be used solely or in combination of two or more kinds.

In the present invention, the molecular weight modifier is used in an amount of generally from 0.01 parts by mass to 10 parts by mass, preferably from 0.1 parts by mass to 5 parts by mass, with respect to 100 parts by mass of the monovinyl monomer.

### (A-2) Suspension Step to Obtain Suspension (Droplets Forming Step)

The polymerizable monomer composition comprising a polymerizable monomer, a colorant, a charge control resin and a softening agent is dispersed in an aqueous medium containing a dispersion stabilizer, and a polymerization initiator is added therein, then the droplets of the polymerizable monomer composition are formed. The method for forming droplets is not particularly limited. The droplets are formed, for example, by means of a device capable of strong stirring such as an in-line type emulsifying and dispersing machine (product name: MILDER; manufactured by Pacific Machinery & Engineering Co., Ltd), and a high-speed emulsification dispersing machine (product name: T. K. HOMOMIXER MARK II; manufactured by PRIMIX Corporation).

Examples of the polymerization initiator include persulfates such as potassium persulfate and ammonium persulfate; azo compounds such as 4,4′-azobis(4-cyanovaleric acid), 2,2′-azobis(2-methyl-N-(2-hydroxyethyl)propionamide), 2,2′-azobis(2-amidinopropane)dihydrochloride, 2,2′-azobis(2,4-dimethylvaleronitrile) and 2,2′-azobisisobutyronitrile; and organic peroxides such as di-t-butylperoxide, benzoylperoxide, t-butylperoxy-2-ethylhexanoate, t-butyl peroxydiethylacetate, t-hexylperoxy-2-ethylbutanoate, diisopropylperoxydicarbonate, di-t-butylperoxyisophthalate and t-butylperoxyisobutyrate. These can be used solely or in combination of two or more kinds. Among them, the organic peroxides are preferably used since they can reduce residual polymerizable monomer and can impart an excellent printing durability.

Among the organic peroxides, preferred are peroxy esters, and more preferred are non-aromatic peroxy esters, i.e. peroxy esters having no aromatic ring, since they have a good initiator efficiency and can reduce a residual polymerizable monomer.

The polymerization initiator may be added after dispersing the polymerizable monomer composition in the aqueous medium and before forming droplets as described above, or may be added to the polymerizable monomer composition before the polymerizable monomer composition is dispersed in the aqueous medium.

The added amount of the polymerization initiator used in the polymerization of the polymerizable monomer composition is preferably from 0.1 parts by mass to 20 parts by mass, more preferably from 0.3 parts by mass to 15 parts by mass, still more preferably from 1 part by mass to 10 parts by mass, with respect to 100 parts by mass of the monovinyl monomer.

In the present invention, the aqueous medium means a medium containing water as a main component.

In the present invention, the dispersion stabilizer is preferably added to the aqueous medium. Examples of the dispersion stabilizer include inorganic compounds including sulfates such as barium sulfate and calcium sulfate; carbonates such as barium carbonate, calcium carbonate and magnesium carbonate; phosphates such as calcium phosphate; metal oxides such as aluminum oxide and titanium oxide; and metal hydroxides such as aluminum hydroxide, magnesium hydroxide and iron(II) hydroxide; and organic compounds including water-soluble polymers such as polyvinyl alcohol, methyl cellulose and gelatin; anionic surfactants; nonionic surfactants; and ampholytic surfactants. These dispersion stabilizers can be used solely or in combination of two or more kinds.

Among the above dispersion stabilizers, colloid of inorganic compounds, particularly colloid of hardly water-soluble metal hydroxide, is preferable. The use of the colloid of inorganic compounds, particularly of hardly water-soluble metal hydroxide makes it possible to narrow a particle size distribution of the colored resin particles and reduce the amount of the dispersion stabilizer remaining after washing, thus the obtained toner becomes capable of reproducing clear images and having excellent environmental stability.

### (A-3) Polymerization Step

After the droplets are formed as described in the above (A-2), the obtained aqueous dispersion medium is heated to start polymerization. Thereby, an aqueous dispersion of colored resin particles is formed.

The polymerization temperature of the polymerizable monomer composition is preferably 50° C. or more, more preferably from 60° C. to 95° C. The polymerization reaction time is preferably from 1 hour to 20 hours, more preferably from 2 hours to 15 hours.

The colored resin particles may be used as they are to obtain polymerized toner by adding an external additive. It is preferable to make the so-called core-shell type (or “capsule type”) colored resin particle by using the above-mentioned colored resin particle as a core layer and forming a shell layer, which is different from the core layer, around the core layer. The core-shell type colored resin particles can take a balance of lowering fixing temperature and prevention of aggregation at storage, since the core layer including a substance having a low softening point is covered with a substance having a higher softening point.

A method for producing the above-mentioned core-shell type colored resin particles using the above-mentioned colored resin particles is not particularly limited, and they can be produced by any conventional method. The in situ polymerization method and the phase separation method are preferable from the viewpoint of production efficiency.

A method for producing the core-shell type colored resin particles according to the in situ polymerization method will be hereinafter described.

A polymerizable monomer for forming a shell layer (a polymerizable monomer for shell) and a polymerization initiator are added to an aqueous medium in which the colored resin particles are dispersed, followed by polymerization, thereby the core-shell type colored resin particles can be obtained.

As the polymerizable monomer for shell, the above-mentioned polymerizable monomer can be similarly used. Among the polymerizable monomers, any monomer which provides a polymer having Tg of more than 80° C. such as styrene, acrylonitrile and methyl methacrylate is preferably used solely or in combination of two or more kinds.

Examples of the polymerization initiator used for polymerization of the polymerizable monomer for shell include water-soluble polymerization initiators including metal persulfates such as potassium persulfate and ammonium persulfate; and azo-type initiators such as 2,2′-azobis(2-methyl-N-(2-hydroxyethyl)propionamide) and 2,2′-azobis(2-methyl-N-(1,1-bis(hydroxymethyl)-2-hydroxyethyl)propionamide). These polymerization initiators can be used solely or in combination of two or more kinds. The amount of the polymerization initiator is preferably from 0.1 parts by mass to 30 parts by mass, more preferably from 1 part by mass to 20 parts by mass, with respect to 100 parts by mass of the polymerizable monomer for shell.

The polymerization temperature of the shell layer is preferably 50° C. or more, more preferably from 60° C. to 95° C. The polymerization reaction time is preferably from 1 hour to 20 hours, more preferably from 2 hours to 15 hours.

### (A-4) Steps of Washing, Filtering, Dehydrating and Drying

It is preferable that the aqueous dispersion of the colored resin particles obtained by the polymerization is subjected to operations including filtering, washing for removing the dispersion stabilizer, dehydrating, and drying by several times as needed after the polymerization, according to any conventional method.

In the washing method, when the inorganic compound is used as the dispersion stabilizer, it is preferable that acid or alkali is added to the aqueous dispersion of colored resin particles, thereby the dispersion stabilizer is dissolved in water and removed. When colloid of hardly water-soluble inorganic hydroxide is used as the dispersion stabilizer, it is preferable that acid is added to adjust pH of the aqueous dispersion of colored resin particles to 6.5 or less. Examples of the acid to be added include inorganic acids such as sulfuric acid, hydrochloric acid and nitric acid, and organic acids such as formic acid and acetic acid. Particularly, sulfuric acid is suitable for high removal efficiency and small impact on production facilities.

The methods for dehydrating and filtering are not particularly limited, and any of various known methods can be used. For example, a centrifugal filtration method, a vacuum filtration method and a pressure filtration method can be used. Also, the drying method is not particularly limited, and any of various methods can be used.

### (B) Pulverization Method

In the case of producing the colored resin particles by employing the pulverization method, the following processes are performed.

First, a binder resin, a colorant, a charge control resin, a softening agent, and other additives which are added if required, are mixed by means of a mixer such as a ball mill, a V type mixer, FM mixer (: product name), a high-speed dissolver, or an internal mixer. Next, the above-obtained mixture is kneaded while heating by means of a press kneader, a twin screw kneading machine or a roller. The obtained kneaded product is coarsely pulverized by means of a pulverizer such as a hammer mill, a cutter mill or a roller mill, followed by finely pulverizing by means of a pulverizer such as a jet mill or a high-speed rotary pulverizer, and classifying into desired particle diameters by means of a classifier such as an air classifier or an airflow classifier. Thereby, colored resin particles produced by the pulverization method can be obtained.

Incidentally, the binder resin, the colorant, the charge control resin and the softening agent and other additives which are added if required, used in the above-mentioned “(A) Suspension polymerization method” can be used in the pulverization method. In like manner of the colored resin particles obtained by the above-mentioned “(A) Suspension polymerization method”, the colored resin particles obtained by the pulverization method as well can be used in any method such as the in situ polymerization method to produce the core-shell type colored resin particles.

As the binder resin, other resins which are conventionally and broadly used for toners can be used. Specific examples of the binder resin used in the pulverization method include polystyrene, styrene-alkyl(meth)acrylate copolymers, polyester resins and epoxy resins.

As described above, in order to set the glass transition temperature to 33° C. to 55° C., it is preferred that the copolymer has a content ratio of styrene in a range of from 55% by mass to 75% by mass and a content ratio of an alkyl(meth)acrylate from 25% by mass to 45% by mass.

### 2. Colored Resin Particles

The colored resin particles are obtained by the above production method such as (A) Suspension polymerization method or (B) Pulverization method.

Hereinafter, the colored resin particles constituting the toner will be described. The colored resin particles hereinafter include both core-shell type colored resin particles and colored resin particles which are not core-shell type.

The volume average particle diameter (Dv) of the colored resin particles is preferably from 4 μm to 12 μm, and more preferably from 5 μm to 10 μm. When the volume average particle diameter (Dv) is less than 4 μm, toner flowability may decrease and may deteriorate transferability or decrease image density. When the volume average particle diameter (Dv) is more than 12 μm, image resolution may decrease.

For the colored resin particles, the ratio (Dv/Dp) between the volume average particle diameter (Dv) and the number average particle diameter (Dp) is preferably from 1.0 to 1.3, and more preferably from 1.0 to 1.2. When the ratio Dv/Dp is more than 1.3, there may be a decrease in transferability, image density and resolution. The volume average particle diameter and number average particle diameter of the colored resin particles can be measured by means of a particle size analyzer (product name: MULTISIZER, manufactured by: Beckman Coulter, Inc.), for example.

The average circularity of the colored resin particles is preferably from 0.96 to 1.00, more preferably from 0.97 to 1.00, and even more preferably from 0.98 to 1.00, from the viewpoint of image reproducibility.

When the average circularity of the colored resin particles is less than 0.96, thin line reproducibility in printing may deteriorate.

In the present invention, “circularity” is defined as a value obtained by dividing the perimeter of a circle having the same area as the projected area of a particle image by the perimeter of the particle image. Also in the present invention, “average circularity” is used as a simple method for quantitatively representing the shape of the particles and is an indicator that shows the degree of the surface roughness of the colored resin particles. The average circularity is 1 when the colored resin particles are perfectly spherical, and it gets smaller as the surface shape of the colored resin particles becomes more complex.

### 3. Method for Producing the Toner

In the present invention, the external addition is conducted by mixing and stirring the above described colored resin particles with an external additive, thereby the external additive is added on surfaces of the colored resin particles to make a one-component toner (developer). The one-component toner may be further mixed and stirred together with carrier particles to make a two-component toner.

The mixer for performing the external addition is not particularly limited as long as it is a mixer capable of add the external additive on the surface of the colored resin particles. For example, the external addition can be performed by means of a mixing machine capable of mixing and stirring, such as FM MIXER (: product name, manufactured by NIPPON COKE & ENGINEERING CO., LTD.), SUPER MIXER (: product name, manufactured by KAWATA Manufacturing Co., Ltd.), Q MIXER (: product name, manufactured by NIPPON COKE & ENGINEERING CO., LTD.), MECHANOFUSION SYSTEM (: product name, manufactured by Hosokawa Micron Corporation) and MECHANOMILL (: product name, manufactured by Okada Seiko Co., Ltd.).

As the external additive, examples include inorganic fine particles made of silica, titanium oxide, aluminum oxide, zinc oxide, tin oxide, calcium carbonate, calcium phosphate and/or cerium oxide, and organic fine particles made of polymethyl methacrylate resin, silicone resin and/or melamine resin. Among them, inorganic fine particles are preferred. Among inorganic fine particles, silica and/or titanium oxide is preferred, and fine particles made of silica are particularly preferred.

These external additives can be used alone or in combination of two or more kinds. It is particularly preferable to use two or more kinds of silica fine particles having different particle diameters.

In the present invention, the amount of the external additive used is generally from 0.05 parts by mass to 6 parts by mass, and preferably from 0.2 parts by mass to 5 parts by mass, with respect to 100 parts by mass of the colored resin particles. When the added amount of the external additive is less than 0.05 parts by mass, the toner may be left untransferred. When the added amount of the external additive is more than 6 parts by mass, fog may be generated.

### 4. Toner of the Present Invention

The toner of the present invention obtained through the steps exemplified above is a toner for developing electrostatic images, comprising colored resin particles comprising a binder resin, a colorant, a charge control resin and a softening agent, and an external additive, wherein the charge control resin is a copolymer having a composition in which a content ratio of a methyl methacrylate monomer unit is from 85.0% by mass to 99.7% by mass; a content ratio of a quaternary ammonium salt group-containing (meth)acrylate monomer unit is from 0.3% by mass to 15.0% by mass; and a content ratio of a vinyl-based monomer unit other than the methyl methacrylate monomer unit and the quaternary ammonium salt group-containing (meth)acrylate monomer unit, is from 0% by mass to 14.7% by mass, and wherein a content ratio of the charge control resin is from 0.2 parts by mass to 4.0 parts by mass, with respect to 100 parts by mass of the binder resin.

As described above, in the toner of the present invention, a copolymer having a constituent monomer unit composition in which the charge amount and polarity of the toner do not become too high even if the content ratio of the charge control resin in the colored resin particles is increased for the purpose of improving printing durability is used as a charge control resin, whereby enabling to satisfy the required levels of printing durability under high temperature and high humidity and conveyance amount stability on the developing roller, which are required for recent toners.

The colored resin particles containing the binder resin, the colorant, the charge control resin and the softening agent, and the external additive contained in the toner of the present invention were described in detail in 1. Method for Producing Colored Resin Particles, the description is omitted.

Further, in the present invention, a glass transition temperature of the charge control resin is set from 50° C. to 85° C., and the binder resin is made as a copolymer containing 55% by mass to 75% by mass of a styrene monomer unit and 25% by mass to 45% by mass of an alkyl (meth)acrylate monomer unit, and having a glass transition temperature of from 30° C. to 55° C., whereby it is possible to improve low temperature fixability in addition to printing durability and conveyance amount stability, which is preferable.

Although a method for specifying the glass transition temperature of the binder resin is not particularly limited, for example, it can be calculated by using the additivity of the glass transition temperature of the polymer.

It is known that an additivity at an absolute temperature is established for the glass transition temperature of the polymer.

Therefore, when two or more types of monomers are used as the polymerizable monomer, calculation Tg can be calculated by Calculation Formula 1 and Calculation Formula 2 below.

Calculation Tg (K)=(M_{A}+M_{B}+M_{C}+ . . . )/[(M_{A}/Tg_{A})+(M_{B}/Tg_{B})+(M_{C}/Tg_{C})+ . . . ] Calculation Formula 1:

Calculation Tg (° C.)=Calculation Tg (K)−273 Calculation Formula 2:

(in Formula (I) described above, wherein M_{A}, M_{B}, M_{C}, . . . represent an added amount (parts by mass) of each monomer, and Tg_{A}, Tg_{B}, Tg_{C}, . . . represent a glass transition temperature (K) of a homopolymer of each monomer, respectively.)

Furthermore, in the present invention, the content of the quaternary ammonium salt group-containing (meth)acrylate monomer unit in the toner for developing electrostatic images is preferably in a range from 40 ppm to 250 ppm.

The content of the quaternary ammonium salt group-containing (meth)acrylate monomer unit, which is a component of the charge control resin, contained in the toner for developing electrostatic images is preferably from 40 ppm to 250 ppm, more preferably from 50 ppm to 230 ppm, and further preferably from 60 ppm to 200 ppm.

When the content ratio of the quaternary ammonium salt group-containing (meth)acrylate monomer unit contained in the toner for developing electrostatic images exceeds the above ranges, printing density and conveyance amount stability tend to decrease. When the content ratio of the quaternary ammonium salt group-containing (meth)acrylate monomer unit is less than the above ranges, fog is likely to occur, and printing durability under high temperature and high humidity tends to decrease.

In addition, since the charge control resin contains a quaternary ammonium salt group that is a positively chargeable functional group, the toner for developing electrostatic images of the present invention is preferably positively chargeable.

Examples of an index of printing durability in a high temperature and high humidity (H/H) environment include printing durability determined by the following method.

Printing sheets are set in a predetermined printer, and a toner is put in the printer. The printer is allowed to stand in a high temperature and high humidity (H/H) environment for 24 hours, then a continuous printing is performed up to a specified number of sheets at a printing density of 5% in the same environment. Solid pattern printing (100% printing density) is performed every 500 sheets, and the printing density of a solid pattern-printed area is measured using a reflection image densitometer. Further, after that, white solid pattern printing (0% printing density) is performed, and the printer is stopped in the middle of white solid pattern printing, the toner in a non-image area on a photoconductor after development is adhered to an adhesive tape, and the adhesive tape is attached to a printing sheet. Next, a whiteness degree (B) of the printing sheet on which the adhesive tape has been attached is measured using a whiteness meter. Similarly, only an unused adhesive tape is attached on the printing sheet to measure a whiteness degree (A) thereof, and a difference (B−A) between these whiteness degrees is taken as a fog value.

The number of continuous printed sheets that can maintain an image quality at a printing density of equal to or higher than the predetermined threshold value and a fog value of equal to or lower than the predetermined threshold value can be used as an index of printing durability.

Examples of an index of stability of the toner conveyance amount on the developing roller include conveyance amount stability determined by the following method.

Conveyance Amount Stability

(i) Initial Conveyance Amount Measurement

During the printing durability test, after the test of 500 sheets is completed, white solid pattern printing is performed using a printer under a specific environment, and subsequently, white solid pattern printing of a second sheet is stopped in the middle. Thereafter, with respect to the toner adhering to a developing roller, a mass of sucked toner and a suctioned area are measured using a suction-type charge amount measuring device.

Based on the mass of the sucked toner and the suctioned area, an initial conveyance amount (mg/cm²) on the developing roller is calculated from Calculation Formulae 3 and 4 below.

Suctioned area (cm²)=(Radius of suction trace (cm))²×π×Number of suction traces Calculation Formula 3:

Toner conveyance amount on developing roller (mg/cm²)=Mass of sucked toner (mg)/suctioned area (cm²) Calculation Formula 4:

(ii) Final Conveyance Amount Measurement

The toner conveyance amount on the developing roller for a predetermined number of sheets in the printing durability test is calculated in the same manner as in (i), and it is defined as the final conveyance amount (mg/cm²).

(iii) Calculation of Conveyance Amount Stability

From the measurement results of (i) and (ii), the conveyance amount stability is calculated by Calculation Formula 5 below.

Conveyance amount stability=Final conveyance amount/Initial conveyance amount Calculation Formula 5:

Examples of an index of low-temperature fixability include a minimum fixing temperature determined by the following method.

A toner fixing rate at a predetermined temperature is measured using a predetermined printer. The fixing rate is calculated from a ratio of image densities before and after a predetermined tape peeling operation in a black solid area printed on a test paper by the printer. That is, when the image density before tape peeling is ID (before) and the image density after tape peeling is ID (after), the fixing rate can be calculated from Calculation Formula 6 below.

The image density is measured using, for example, a spectrophotometer (product name: Spectroeye, manufactured by X-Rite).

Fixing rate (%)=(ID (after)/ID (before))×100 Calculation Formula 6:

In this fixing test, a fixing temperature at which the fixing rate is equal to or higher than a predetermined threshold is determined as a minimum fixing temperature of the toner.

### EXAMPLES

Hereinafter, the present invention will be described further in detail with reference to examples and comparative examples. However, the present invention is not limited to these examples. Herein, parts and % are based on mass basis unless otherwise noted.

Test methods used in the present examples and comparative examples are as follows.

### 1. Production of Toner

### Example 1

(1) Synthesis of Charge Control Resin

Into a reaction vessel were charged 60 parts of methanol, 20 parts of toluene, 99.5 parts of methyl methacrylate, 0.5 parts of methacrylic acid dimethylaminoethylbenzyl chloride, and 0.2 parts of azobisdimethylvaleronitrile, and they were allowed to react at 60° C. for 12 hours while stirring. Subsequently, the solvent was removed by distillation under reduced pressure to obtain charge control resin 1 composed of a quaternary ammonium salt group-containing copolymer having a Tg of 83° C.

(2) Preparation of Toner for Developing Electrostatic Images

Seventy parts of styrene and 30 parts of n-butyl acrylate as monovinyl monomers, 7 parts of carbon black (product name: #25B, manufactured by Mitsubishi Chemical Corporation) as a black colorant, 0.7 parts of divinylbenzene as a crosslinkable polymerizable monomer, and 1.0 part of t-dodecyl mercaptan as a molecular weight modifier were wet pulverized using a media-type wet pulverizer, and then 1.5 parts of the charge control resin 1 obtained in (1) as a charge control agent and 20 parts of behenyl stearate (molecular formula: C₁₇H₃₅—COO—C₂H₄₅, melting point: 70° C., acid value: 0.1 mgKOH/g, hydroxyl value: 0.3 mgKOH/g) as a softening agent were further mixed to obtain a polymerizable monomer composition.

On the other hand, in a stirring tank, at room temperature, an aqueous solution in which 4.1 parts of sodium hydroxide was dissolved in 50 parts of ion exchanged water was gradually added under stirring to an aqueous solution in which 7.4 parts of magnesium chloride was dissolved in 250 parts of ion exchanged water to prepare a magnesium hydroxide colloidal dispersion (3.0 parts of magnesium hydroxide).

Into the magnesium hydroxide colloidal dispersion obtained as described above was charged the polymerizable monomer composition at room temperature, the mixture was stirred until droplets were stabilized, and 5 parts of t-butylperoxy-2-ethylhexanoate (product name: PERBUTYL O, manufactured by NOF Corporation) as a polymerization initiator was added thereto. Thereafter, droplets of the polymerizable monomer composition were formed by high shear stirring at a rotational speed of 15,000 rpm, using an in-line type emulsifying disperser (product name: Milder, manufactured by Pacific Machinery & Engineering Co., Ltd).

A suspension in which the droplets of the polymerizable monomer composition obtained as described above are dispersed (polymerizable monomer composition dispersion) was charged into a reactor furnished with a stirring blade, and the temperature thereof was raised to 90° C. to start a polymerization reaction. When a polymerization conversion reached almost 100%, 1.5 parts of methyl methacrylate (polymerizable monomer for shell) and 0.10 parts of 2,2′-azobis(2-methyl-N-(2-hydroxyethyl)propionamide) (polymerization initiator for shell, product name: VA-086, manufactured by Wako Pure Chemical Industries, Ltd., water-soluble) dissolved in 20 parts of ion-exchanged water were added to the reactor. Thereafter, polymerization was continued by maintaining the temperature at 90° C. for further 3 hours, and then the reaction was stopped by water cooling to obtain an aqueous dispersion of colored resin particles.

The aqueous dispersion of colored resin particles obtained above was subjected to acid washing, in which sulfuric acid was added dropwise to be pH of 6.5 or less while stirring at room temperature. Subsequently, filtration separation was performed, 500 parts of ion-exchanged water was added to the obtained solid content to make a slurry again, and a water washing treatment (washing, filtration and dehydration) was repeatedly performed several times. Next, filtration separation was performed, and the obtained solid content was placed in a container of a dryer and dried at 45° C. for 48 hours to obtain dried colored resin particles.

To 100 parts of the colored resin particles, 0.7 parts of silica fine particles A having a number average primary particle diameter of 10 nm and 1 part of silica fine particles B having a number average primary particle diameter of 55 nm hydrophobized with amino-modified silicone oil were added, and the mixture was mixed and subjected to external addition treatment to prepare the toner for developing electrostatic images of Example 1, using a high-speed agitator (product name: FM mixer, manufactured by: Nippon Coke & Engineering Co., Ltd.).

### Example 2

(1) Synthesis of Charge Control Resin

Into a reaction vessel were charged 60 parts of methanol, 20 parts of toluene, 99.7 parts of methyl methacrylate, 0.3 parts of methacrylic acid dimethylaminoethylbenzyl chloride, and 0.2 parts of azobisdimethylvaleronitrile, and they were allowed to react at 60° C. for 12 hours while stirring. Subsequently, the solvent was removed by distillation under reduced pressure to obtain charge control resin 2 composed of a quaternary ammonium salt group-containing copolymer having a Tg of 82° C.

(2) Preparation of Toner for Developing Electrostatic Images

A toner for developing electrostatic images of Example 2 was produced in the same manner as in Example 1 except that 3.0 parts of the charge control resin 2 obtained in (1) above was added.

### Example 3

(1) Synthesis of Charge Control Resin

Into a reaction vessel were charged 60 parts of methanol, 20 parts of toluene, 86.0 parts of methyl methacrylate, 8.0 parts of n-butyl acrylate, 6.0 parts of methacrylic acid dimethylaminoethylbenzyl chloride, and 0.2 parts of azobisdimethylvaleronitrile, and they were allowed to react at 60° C. for 12 hours while stirring. Subsequently, the solvent was removed by distillation under reduced pressure to obtain charge control resin 3 composed of a quaternary ammonium salt group-containing copolymer having a Tg of 65° C.

(2) Preparation of Toner for Developing Electrostatic Images

A toner for developing electrostatic images of Example 3 was produced in the same manner as in Example 1 except that 0.3 parts of the charge control resin 3 obtained in (1) above was added.

### Example 4

(1) Synthesis of Charge Control Resin

Into a reaction vessel were charged 60 parts of methanol, 20 parts of toluene, 85.0 parts of methyl methacrylate, 13.0 parts of styrene, 2.0 parts of methacrylic acid dimethylaminoethylbenzyl chloride, and 0.2 parts of azobisdimethylvaleronitrile, and they were allowed to react at 60° C. for 12 hours while stirring. Subsequently, the solvent was removed by distillation under reduced pressure to obtain charge control resin 4 composed of a quaternary ammonium salt group-containing copolymer having a Tg of 84° C.

(2) Preparation of Toner for Developing Electrostatic Images

A toner for developing electrostatic images of Example 4 was produced in the same manner as in Example 1 except that 0.6 parts of the charge control resin 4 obtained in (1) above was added.

### Example 5

(1) Synthesis of Charge Control Resin

Into a reaction vessel were charged 60 parts of methanol, 20 parts of toluene, 88.0 parts of methyl methacrylate, 12.0 parts of methacrylic acid dimethylaminoethylbenzyl chloride, and 0.2 parts of azobisdimethylvaleronitrile, and they were allowed to react at 60° C. for 12 hours while stirring. Subsequently, the solvent was removed by distillation under reduced pressure to obtain charge control resin 5 composed of a quaternary ammonium salt group-containing copolymer having a Tg of 81° C.

(2) Preparation of Toner for Developing Electrostatic Images

A toner for developing electrostatic images of Example 5 was produced in the same manner as in Example 1 except that 0.12 parts of the charge control resin 5 obtained in (1) above was added.

### Comparative Example 11

(1) Synthesis of Charge Control Resin

Into a reaction vessel were charged 60 parts of methanol, 20 parts of toluene, 90.0 parts of styrene, 8.0 parts of n-butyl acrylate, 2.0 parts of methacrylic acid dimethylaminoethylbenzyl chloride, and 0.2 parts of azobisdimethylvaleronitrile, and they were allowed to react at 60° C. for 12 hours while stirring. Subsequently, the solvent was removed by distillation under reduced pressure to obtain charge control resin 6 composed of a quaternary ammonium salt group-containing copolymer having a Tg of 82° C.

(2) Preparation of Toner for Developing Electrostatic Images

A toner for developing electrostatic images of Comparative Example 1 was produced in the same manner as in Example 1 except that 1.6 parts of the charge control resin 6 obtained in (1) above was added.

### Comparative Example 21

(1) Synthesis of Charge Control Resin

Into a reaction vessel were charged 60 parts of methanol, 20 parts of toluene, 95.0 parts of styrene, 4.0 parts of n-butyl acrylate, 1.0 parts of methacrylic acid dimethylaminoethylbenzyl chloride, and 0.2 parts of azobisdimethylvaleronitrile, and they were allowed to react at 60° C. for 12 hours while stirring. Subsequently, the solvent was removed by distillation under reduced pressure to obtain charge control resin 7 composed of a quaternary ammonium salt group-containing copolymer having a Tg of 68° C.

(2) Preparation of Toner for Developing Electrostatic Images

A toner for developing electrostatic images of Comparative Example 2 was produced in the same manner as in Example 1 except that 3.0 parts of the charge control resin 7 obtained in (1) above was added.

### Comparative Example 3

(1) Synthesis of Charge Control Resin

Into a reaction vessel were charged 60 parts of methanol, 20 parts of toluene, 79.8 parts of methyl methacrylate, 15.0 parts of styrene, 5.0 parts of n-butyl acrylate, 0.2 parts of methacrylic acid dimethylaminoethylbenzyl chloride, and 0.2 parts of azobisdimethylvaleronitrile, and they were allowed to react at 60° C. for 12 hours while stirring. Subsequently, the solvent was removed by distillation under reduced pressure to obtain charge control resin 8 composed of a quaternary ammonium salt group-containing copolymer having a Tg of 72° C.

(2) Preparation of Toner for Developing Electrostatic Images

A toner for developing electrostatic images of Comparative Example 3 was produced in the same manner as in Example 1 except that 15.0 parts of the charge control resin 8 obtained in (1) above was added.

2. Glass Transition Temperature (Tg) of Copolymer of Charge Control Resin

In accordance with ASTM D3418-82, a temperature showing the maximum endothermic peak (maximum endothermic peak temperature) of each of the charge control resins 1 to 7 was measured. More specifically, a copolymer sample was heated at a heating rate of 10° C./minute using a differential scanning calorimeter (product name: SSC5200, manufactured by Seiko Instruments & Electronics Ltd.), a temperature showing the maximum endothermic peak of a DSC curve obtained through the process was measured, and the temperature was defined as the glass transition temperature (Tg) of the copolymer.

The Tg measurement results of the charge control resins 1 to 7 are summarized in Table 1 together with the composition of each charge control resin. In Table 1 below, “MMA” means the added amount of methyl methacrylate, “ST” means the added amount of styrene, and “BA” means the added amount of n-butyl acrylate. Also, “quaternary ammonium salt group-containing acrylate” means the added amount of methacrylic acid dimethylaminoethylbenzyl chloride.

TABLE 1

| | | | | Quaternary ammonium salt | |
|---|---|---|---|---|---|
| | MMA | ST | BA | group-containing acrylate | Tg (° C.) |
| Resin 1 | 99.5 | — | — | 0.5 | 83 |
| Resin 2 | 99.7 | — | — | 0.3 | 82 |
| Resin 3 | 86.0 | — | 8.0 | 6.0 | 65 |
| Resin 4 | 85.0 | 13.0 | — | 2.0 | 84 |
| Resin 5 | 88.0 | — | — | 12.0 | 81 |
| Resin 6 | — | 90.0 | 8.0 | 2.0 | 82 |
| Resin 7 | — | 95.0 | 4.0 | 1.0 | 68 |
| Resin 8 | 79.8 | 15.0 | 5.0 | 0.2 | 72 |

3. Characteristic Evaluation of Colored Resin Particles and Toners

The characteristics of the toners of Examples 1 to 4 and Comparative Examples 1 to 3 were examined. Details are as follows.

(1) Glass Transition Temperature (Tg) of Binder Resin in Toner

From the constitution of the polymerizable monomer in the binder resin, the glass transition temperature (Tg) of the binder resin was calculated using Calculation Formula 1 and Calculation Formula 2 above that use additivity.

(2) Heat Resistant Storage Stability of Toner

After 10 g of each toner was put in a 100 mL polyethylene container, the container was hermetically sealed. Then, the container was submerged in a constant temperature water bath at a predetermined temperature and taken out after a lapse of 8 hours. The constant temperature water bath was set at from 55° C. to 60° C. in 1° C. increments. From the container taken out, the toner was transferred onto a 42-mesh sieve so as not to be vibrated as much as possible, and set in a powder characteristic tester (product name: Powder Tester PT-R manufactured by Hosokawa Micron Corporation). The amplitude of the sieve was set to 1.0 mm, and the sieve was vibrated for 30 seconds. Then, the mass of the toner remaining on the sieve was measured, and this was defined as the mass of the aggregated toner.

The maximum temperature at which the mass of the aggregated toner was 0.5 g or less was defined as the heat resistant temperature.

(3) Printing Evaluation of Toner

(a) Measurement of Fixing Temperature of Toner

A fixing test was performed using a commercially available non-magnetic one-component development printer (resolution 600 dpi, printing speed 28 sheets/min) which was modified so that the temperature of a fixing roller could be changed. In the fixing test, the temperature of the fixing roller of the modified printer was changed, and the toner fixing rate at each temperature was measured.

The fixing rate was calculated from a ratio of image densities before and after a tape peeling operation in a black solid area printed on a test paper by the modified printer. That is, the image density before tape peeling was defined as ID (before) and the image density after tape peeling was defined as ID (after), the fixing rate was calculated from Calculation Formula 5 above.

Here, the tape peeling operation means a series of operations including: attaching an adhesive tape (product name: SCOTCH MENDING TAPE 810-3-18, manufactured by Sumitomo 3M Limited) to a measuring part (black solid area) of a test paper, pressing at a constant pressure to be adhered, and then peeling the adhesive tape in a direction along the paper at a constant speed. Moreover, the image density was measured using a spectrophotometer (product name: SPECTROEYE, manufactured by X-Rite Corporation). In this fixing test, the minimum fixing roller temperature at which the fixing rate was 80% or more was defined as the minimum fixing temperature of the toner.

(3) Printing Durability Test in High Temperature and High Humidity Environment

Printing sheets were set in the printer, and a toner was put in the printer. The printer was allowed to stand in a high temperature and high humidity (H/H) environment at a temperature of 32.5° C. and a humidity of 80% RH for 24 hours, then a continuous printing was performed up to 15,000 sheets at a printing density of 5% in the same environment. Solid pattern printing (100% printing density) was performed every 500 sheets, and the printing density of a solid pattern-printed area was measured using a reflection image densitometer (product name: RD918, manufactured by Macbeth). Further, after that, white solid pattern printing (0% printing density) was performed, and the printer was stopped in the middle of white solid pattern printing, then the toner in a non-image area on a photoconductor after development was adhered to an adhesive tape (product name: Scotch Mending Tape 810-3-18, manufactured by Sumitomo 3M Limited), and the adhesive tape was attached to a printing sheet. Next, a whiteness degree (B) of the printing sheet on which the adhesive tape had been attached was measured using a whiteness meter (manufactured by Nippon Denshoku Industries Co., Ltd.). Similarly, only an unused adhesive tape was attached on the printing sheet to measure a whiteness degree (A) thereof, and a difference (B−A) between these whiteness degrees was taken as a fog value. The smaller value indicates that fog is less, and image quality is better.

The number of continuous printed sheets that could maintain an image quality at a printing density of 1.3 or more and a fog value of 5 or less was examined.

(4) Evaluation of Conveyance Amount Stability of Toner

(i) Initial Conveyance Amount Measurement

During the printing durability test, after the test of 500 sheets was completed, white solid pattern printing was performed using a printer (printing speed: 40 ppm) in an environment of 32.5° C. and 80%, and subsequently, white solid pattern printing of a second sheet was stopped in the middle. Thereafter, with respect to the toner adhering to a developing roller, a mass of sucked toner and a suctioned area were measured using a suction-type charge amount measuring device (product name: 210HS-2A, manufactured by TREK JAPAN)).

Based on the mass of the sucked toner and the suctioned area, an initial conveyance amount (mg/cm²) on the developing roller was calculated from Calculation Formulae 3 and 4 above.

(ii) Final Conveyance Amount Measurement

The toner conveyance amount on the developing roller after 15,000 sheets of the printing durability test or at the number of sheets when fog occurred was calculated in the same manner as in (i), and it was defined as the final conveyance amount (mg/cm²).

(iii) Calculation of Conveyance Amount Stability

From the measurement results of (i) and (ii), the conveyance amount stability was calculated by Calculation Formula 5 above.

In this test, the conveyance amount stability required for the toner is that the final conveyance amount stability is 1.4 or less.

Table 2 shows measurement and evaluation results of the toners for developing electrostatic images of Examples 1 to 5 and Comparative Examples 1 to 3. In Table 2 below, “HH durability (sheets)” means the number of continuous printed sheets in a printing durability test in a high temperature and high humidity (H/H) environment.

TABLE 2

| | | | Content ratio of | | | | | |
|---|---|---|---|---|---|---|---|---|
| | | | quaternary | Heat resistant | | | | |
| | | | ammonium salt | storage | | | | |
| | Charge | | group containing | stability | Printing evaluation | | | |
| | control resin | | acrylate | of toner | Minimum | | | Tg of |
| | | Added | monomer | Heat resistant | fixing | H/H | Conveyance | Binder |
| | | amount | unit in toner | temperature | temperature | Durability | Amount | Resin |
| | Type | (parts) | ppm | (° C.) | (° C.) | (sheets) | Stabiltiy | (° C.) |
| Example 1 | Resin | 1.5 | 75 | 58 | 135 | >15000 | 1.12 | 36 |
| | 1 | | | | | | | |
| Example 2 | Resin | 3.0 | 90 | 57 | 140 | 13000 | 1.20 | 36 |
| | 2 | | | | | | | |
| Example 3 | Resin | 0.3 | 180 | 58 | 135 | >15000 | 1.18 | 36 |
| | 3 | | | | | | | |
| Example 4 | Resin | 0.6 | 120 | 57 | 135 | >15000 | 1.29 | 36 |
| | 4 | | | | | | | |
| Example 5 | Resin | 0.12 | 145 | 57 | 135 | 12000 | 1.22 | 36 |
| | 5 | | | | | | | |
| Comparative | Resin | 1.6 | 320 | 58 | 135 | 8000 | 1.66 | 47 |
| Example 1 | 6 | | | | | | | |
| Comparative | Resin | 3.0 | 300 | 55 | 130 | 5000 | 1.89 | 47 |
| Example 2 | 7 | | | | | | | |
| Comprave | Resin | 15.0 | 300 | 57 | 135 | 9000 | 1.75 | 36 |
| Example 3 | 8 | | | | | | | |

5. Summary of Toner Evaluation

Hereinafter, the toner evaluation will be studied with reference to Table 1 and Table 2.

First, the toners of Comparative Examples 1 and 2 will be studied. From Table 1, in the toners of Comparative Examples 1 and 2, Resin 6 and Resin 7 used as the charge control resins do not contain a methyl methacrylate monomer unit.

As shown in Table 2, in the toners of Comparative Examples 1 and 2 containing a charge control resin that does not contain a methyl methacrylate monomer unit, the number of printing durability evaluation in a high temperature and high humidity environment was low as 8000 sheets or less, thus the printing durability in a high temperature and high humidity environment was low.

Further, the conveyance amount stability was high as 1.66 or more, and the conveyance amount stability on the developing roller was low.

Next, the toner of Comparative Example 3 will be studied. From Table 1, in the toner of Comparative Example 3, Resin 8 used as the charge control resin has a content ratio of the methyl methacrylate monomer unit of 79.8%, and a content ratio of the quaternary ammonium salt group-containing (meth)acrylate monomer unit of 0.2%.

As shown in Table 2, in the toner of Comparative Example 3 containing the charge control resin 8 in which a content ratio of methyl methacrylate monomer unit was 79.8% and a content ratio of quaternary ammonium salt group-containing (meth)acrylate monomer unit was 0.2%, the number of printing durability evaluation in a high temperature and high humidity environment was low as 9000 sheets, thus the printing durability in a high temperature and high humidity environment was low.

Furthermore, the conveyance amount stability was high as 1.75, and the conveyance amount stability on the developing roller was low.

Subsequently, the toners of Examples 1 to 5 will be studied. From Table 1, in the toners of Examples 1 to 5, Resin 1 to Resin 5 used as the charge control resins contain a methyl methacrylate monomer unit in a range of 85% or more and 99.7% or less and an quaternary ammonium salt group-containing (meth)acrylate monomer unit in a range of 0.3% or more and 12.0% or less.

Thus, in the toners of Examples 1 to 5 using Resin 1 to Resin 5 containing a methyl methacrylate monomer unit in a range of 85% or more and 99.5% or less and a quaternary ammonium salt group-containing (meth)acrylate monomer unit in a range of 0.3% or more and 12.0% or less, as shown in Table 2, the number of printing durability evaluation in a high temperature and high humidity environment was high as 12,000 sheets or more, which was higher than the toners of Comparative Examples 1 to 3.

In addition, the conveyance amount stability was low as 1.29 or less, thus the conveyance amount was stable as compared with the toners of Comparative Examples 1 to 3.

As shown in Table 2, Resin 3 used in the toner of Example 3 contains 8.0% of an n-butyl acrylate monomer unit that is a vinyl-based monomer unit other than the methyl methacrylate monomer unit and the quaternary ammonium salt group-containing (meth)acrylate monomer unit, and Resin 4 used in the toner of Example 4 contains 13% of a styrene monomer unit that is a vinyl-based monomer other than the methyl methacrylate monomer unit and the quaternary ammonium salt group-containing (meth)acrylate monomer unit. However, as compared with the toners of Example 1, Example 2 and Example 5 using Resin 1, Resin 2 or Resin 5 containing no vinyl-based monomer unit other than the methyl methacrylate monomer unit and the quaternary ammonium salt group-containing (meth)acrylate monomer unit, heat resistant storage stability and printing evaluation of the toners were not deteriorated.

Accordingly, it can be seen that the toner for developing electrostatic images according to the present invention having colored resin particles containing a binder resin, a colorant, a charge control resin and a softening agent, and an external additive, in which the charge control resin is a copolymer having a composition in which a content ratio of a methyl methacrylate monomer unit is from 85.0% by mass to 99.7% by mass; a content ratio of a quaternary ammonium salt group-containing (meth)acrylate monomer unit is from 0.3% by mass to 15.0% by mass; and a content ratio of a vinyl-based monomer unit other than the methyl methacrylate monomer unit and the quaternary ammonium salt group-containing (meth)acrylate monomer unit is from 0% by mass to 14.7% by mass, and the charge control resin is contained in an amount of from 0.2 parts by mass to 4.0 parts by mass with respect to 100 parts by mass of the binder resin, is excellent in balance between the printing durability in a high temperature and high humidity environment and the conveyance amount stability on the developing roller.

1. A toner for developing electrostatic images, comprising:
colored resin particles comprising a binder resin, a colorant, a charge control resin and a softening agent, and
an external additive,
wherein the charge control resin is a copolymer having a composition in which a content ratio of a methyl methacrylate monomer unit is from 85.0% by mass to 99.7% by mass; a content ratio of a quaternary ammonium salt group-containing (meth)acrylate monomer unit is from 0.3% by mass to 15.0% by mass; and a content ratio of a vinyl-based monomer unit other than the methyl methacrylate monomer unit and the quaternary ammonium salt group-containing (meth)acrylate monomer unit, is from 0% by mass to 14.7%0 by mass, and
wherein a content ratio of the charge control resin is from 0.2 parts by mass to 4.0 parts by mass, with respect to 100 parts by mass of the binder resin.

2. The toner for developing electrostatic images according to claim 1,
wherein a glass transition temperature of the charge control resin is from 50° C. to 85° C., and
wherein the binder resin is a copolymer having a composition in which a content ratio of a styrene monomer unit is from 55% by mass to 75% by mass, and a content ratio of an alkyl (meth)acrylate monomer unit is from 25% by mass to 45% by mass and having a glass transition temperature of from 30° C. to 55° C.

3. The toner for developing electrostatic images according to claim 1,
wherein a content ratio of the quaternary ammonium salt group-containing (meth)acrylate monomer unit in the toner for developing electrostatic images, is from 40 ppm to 250 ppm.

4. A method for producing a toner for developing electrostatic images, the method comprising:
a suspension step of obtaining a suspension in which droplets of a polymerizable monomer composition comprising at least a polymerizable monomer, a colorant, a charge control resin and a softening agent are dispersed, by suspending the polymerizable monomer composition in an aqueous dispersion medium comprising a dispersion stabilizer, and
a step of obtaining colored resin particles by suspension polymerization of the suspension in the presence of a polymerization initiator,
wherein the charge control resin is a copolymer having a composition in which a content ratio of a methyl methacrylate monomer unit is from 85.0% by mass to 99.7% by mass; a content ratio of a quaternary ammonium salt group-containing (meth)acrylate monomer unit is from 0.3% by mass to 15.0% by mass; and a content ratio of a vinyl-based monomer unit other than the methyl methacrylate monomer unit and the quaternary ammonium salt group-containing (meth)acrylate monomer unit, is from 0% by mass to 14.7%0 by mass, and
wherein an added amount of the charge control resin in the suspension step, is from 0.2 parts by mass to 4 parts by mass, with respect to 100 parts by mass of the polymerizable monomer.
